(19) United States
(12) Patent Application Publication
(10) Pub. No.: US 2012/0268590 A1
(43) Pub. Date: Oct. 25, 2012

(54) EXTREME RANGE PHOTOGRAPHY USED TO COUNTER INSURGENCY (COIN) AND COUNTER IMPROVISED EXPLOSIVE DEVICES (CIED)

(76) Inventor: Michael Costello, Lawrenceville, NJ (US)

(21) Appl. No.: 13/245,806

(22) Filed: Sep. 26, 2011

Related U.S. Application Data
(60) Provisional application No. 61/386,148, filed on Sep. 24, 2010.

(51) Int. Cl. H04N 7/18; G06K 9/62; F41A 33/00; H04N 5/225

(52) U.S. Cl. 348/143; 434/11; 348/E05.024; 348/E07.085

(57) ABSTRACT

Provided is a system and method using extreme range photography for countering insurgency and improvised explosive devices. A weapons-mounted digital camera including a telephoto lens and a wireless communications interface in communication with a mobile computing device are employed to receive one or more images comprising one or more person. The image(s) are then processed, such as by using facial recognition software, to determine if corrective action is appropriate. A method of training personnel to use the system and method is also provided.

### CROSS REFERENCE TO RELATED APPLICATIONS

This application claims priority from U.S. Provisional Patent Application No. 61/386,148 filed on Sep. 24, 2010, by M. Costello titled “EXTREME RANGE PHOTOGRAPHY USED TO COUNTER INSURGENCY (COIN) AND COUNTER IMPROVISED EXPLOSIVE DEVICES (CIED),” which is incorporated herein by reference in its entirety.

### FIELD OF THE INVENTION

This invention generally relates to providing a system and method using extreme range photography to counter insurgency (“COIN”) and to counter improvised explosive devices (“CIED”).

### BACKGROUND OF THE INVENTION

Insurgency, and in particular, remote-controlled improvised explosive devices account for the majority of casualties in recent fighting in Afghanistan. Although the modern battlefield includes numerous examples of advanced weapons systems and methods, for the infantryman on the ground the weaponry in several areas have not significantly changed since the Vietnam war, some 40 years ago.

For example, the modern infantryman still carried an assault rifle, and is vulnerable to mines and improvised explosive devices (“IEDs”). Insurgents have devised many ways of detonating IEDs, but these often require that they observe when a patrol approaches near the IED.

Modern technology, including computers, communications and the advent of compact yet powerful cameras with extreme range photography (“ERP”) capability provide an opportunity for a system and method that would combine these modern devices with new techniques to counter insurgency (“COIN”) and counter improvised explosive devices (“CIED”).

### SUMMARY OF THE INVENTION

An aspect of the present invention provides a system and method to help infantry units on the ground and others protect themselves against IEDs, such as typically encountered in an insurgency. In an aspect of the invention, the method comprises getting to know the people in the unit's area of responsibility (“AOR”), and taking pictures of insurgents watching friendly patrols from extreme distances—typically 100 to over 500 meters—then turning over the pictures with grid coordinates to local policing or other authorities for corrective action, such as follow-up questioning and/or chemical testing of the insurgent suspects.

Also provided are a system and method of using extreme range photography to counter insurgency and to counter improvised explosive devices.

In another aspect of the invention, a weapons-mounted digital camera comprising a telephoto lens and a wireless communications interface in communication with a mobile computing device are employed. The mobile computing device includes a processor and computer memory configured to receive one or more images comprising one or more person from the camera.

In a further aspect of the invention, the system includes a global positioning system, rangefinder and direction finder configured to provide an estimated position of the one or more person in the image(s). In another aspect, a method of training personnel to use the COIN and CIED system and methods is also provided.

### BRIEF DESCRIPTION OF THE DRAWINGS

Embodiments will be described with reference to the following drawing figures, in which like numerals represent like items throughout the figures, and in which:

FIG. 1 is a depiction of an exemplary digital camera/assault rifle that is useful for understanding the present invention.

FIG. 2 is a block diagram of an exemplary system for using photography to counter insurgency and to counter improvised explosive devices that is useful for understanding the present invention.

FIG. 3 is a block diagram of an exemplary system for using photography to counter insurgency and to counter improvised explosive devices that is useful for understanding the present invention.

### DETAILED DESCRIPTION

In the following description, for purposes of explanation, specific numbers, materials and configurations are set forth in order to provide a thorough understanding of the invention. It will be apparent, however, to one having ordinary skill in the art, that the invention may be practiced without these specific details. In some instances, well-known features may be omitted or simplified so as not to obscure the present invention. Furthermore, reference in the specification to “one embodiment” or “an embodiment” means that a particular feature, structure or characteristic described in connection with the embodiment is included in at least one embodiment of the invention. The appearances of the phrase “in an embodiment” in various places in the specification are not necessarily all referring to the same embodiment.

An embodiment of the present invention advantageously provides for an advantageous system and method that combine extreme range photography new techniques to counter insurgency (“COIN”) and counter improvised explosive devices (“CIED”).

In an exemplary embodiment of the invention, a digital compact zoom lens camera (hereinafter, “camera”) may be used on by a unit on patrol. In one embodiment of the invention, preparatory to a patrol's use of the camera, the names of the villages in the unit's area of responsibility (“AOR”) would be identified. The patrol would setup a perimeter, and engage the locals in meeting. For example, in Afghanistan, such a village meeting, or “shura”, might involve sitting for tea. At the meeting, key persons in the AOR are identified, such as local elders or maliks, mullahs, key businessmen and/or landowners, and pictures and/or video is made of these key persons. Also, for identification purposes, pictures may be taken of suspected insurgents watching dismounted patrols from distances. In practice, taking pictures from up to 600 meters has been effective, although greater ranges are also envisioned.

During a subsequent patrol by the unit, state-of-the-art photographic equipment can be used for taking extreme range photographs or video under combat conditions. This is referred to herein as Extreme Range Photography (“ERP”).

For example, in an embodiment of the invention, a patrol may carry a digital camera with a telephoto lens, such as a Nikon P100s, on patrol with them. In an embodiment of the invention, the camera with it's zoom lens can be mounted alone or mounted onto an assault rifle (“AR”), preferably via a Picatinny rail, the AR preferably being mounted using a bipod or the like for stabilization. With the camera, the patrol can photograph insurgents firing on them in order to justify their returning fire, and/or use photos to justify calling in artillery and/or air strikes on suspected insurgents.

The photos may alternatively be used as justification for the local or other security teams to pickup suspects for questioning, chemical testing and possible arrest. Such questioning of the suspect, if performed on an ongoing basis, would also let the suspect know that the patrol knows who he is and that they are watching him

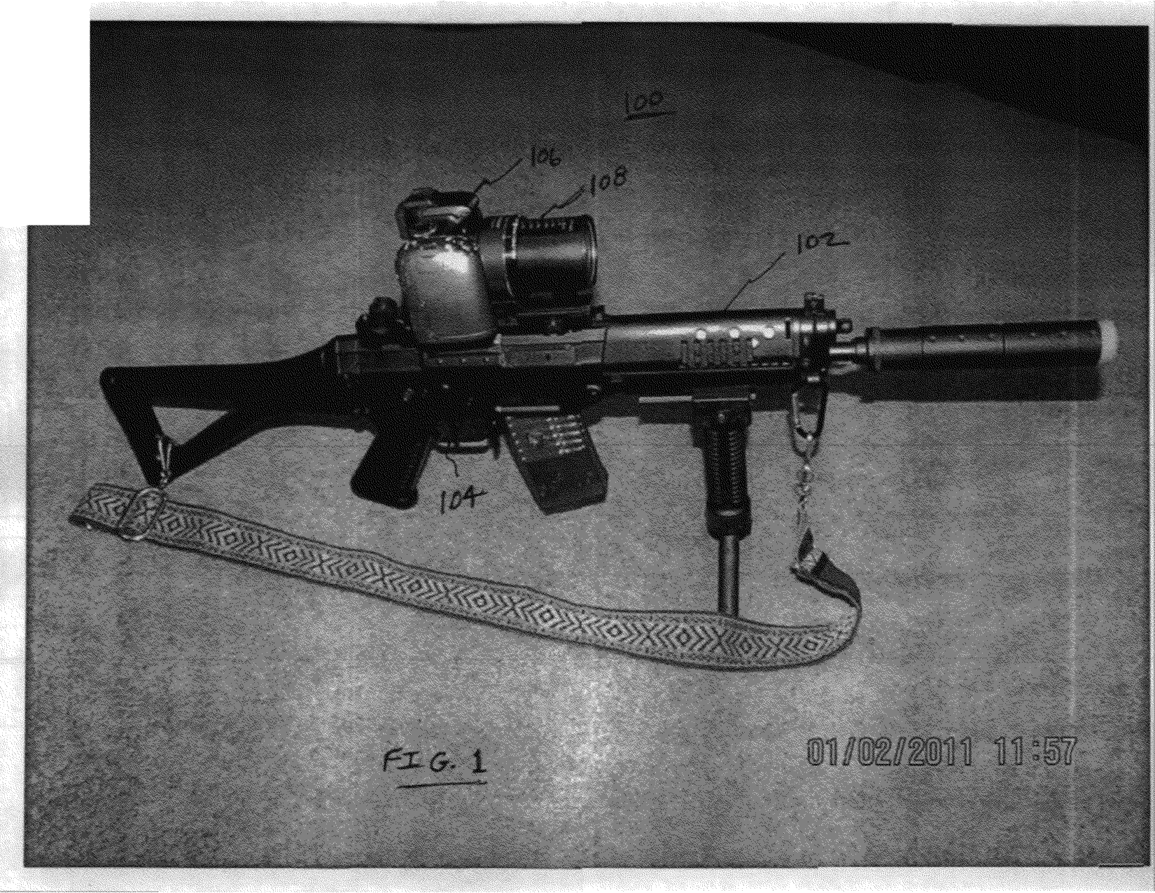

FIG. 1 depicts such a camera/assault rifle arrangement. In an exemplary weapons mounted digital camera/assault rifle embodiment 100, an assault rifle 102 has mounted thereon a digital camera 106 with a telescopic zoom lens 108. The assault rifle's trigger is located at 104. Alternative arrangements are also envisioned.

Numerous cameras are suitable for adaptation and use in a system in accordance with the present invention. For example, testing results show that a Nikon P100 can take a usable photo of a suspected insurgent sitting on a rooftop from a distance of 400 meters.

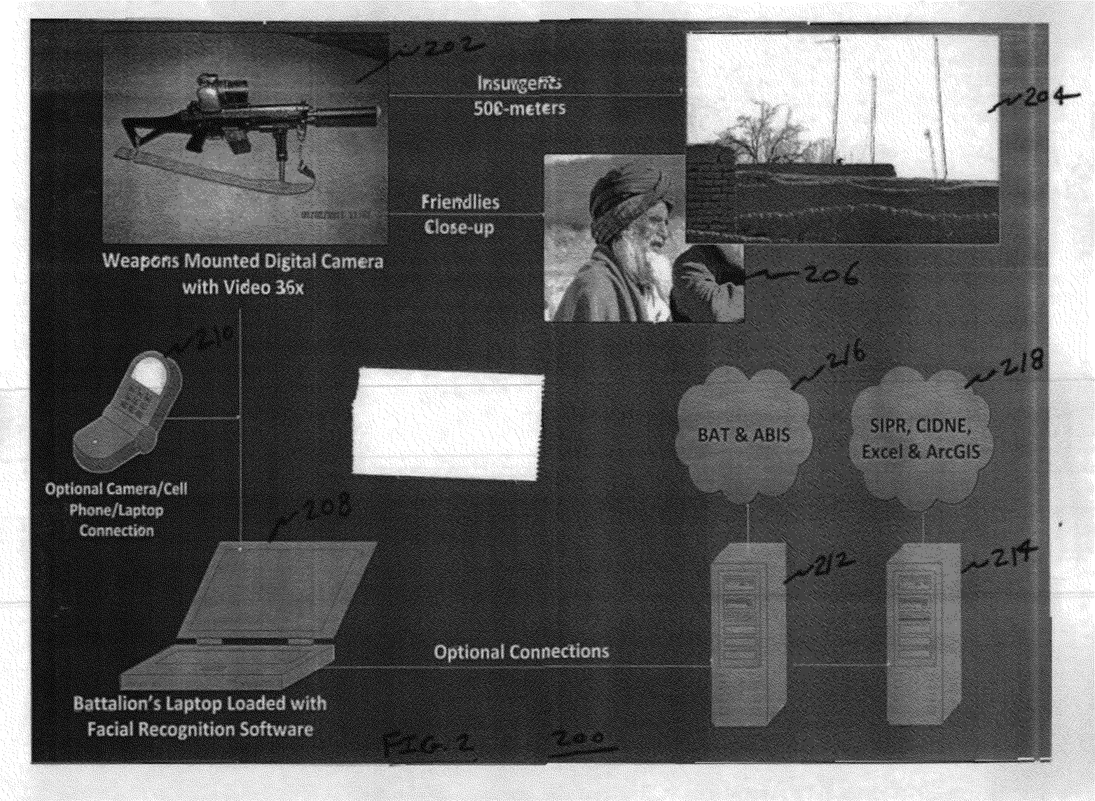

FIG. 2 depicts an exemplary system 200 for using ERP to counter insurgency and to counter improvised explosive devices in accordance with the present invention. In an embodiment of the invention, a weapons mounted digital camera 202 is employed by a patrol top take one or more image 204 or video of a suspected insurgent. Although 36× video is depicted, greater magnification may alternatively be employed. The camera may also be used to acquire close-up images 206 of friendly locals, for later comparison with images 204 taken during a patrol.

In an embodiment of the invention, the digital image information is then communicated to a laptop 208, such as by means of a camera/cellphone/laptop connection 210. The laptop is preferably loaded with facial recognition software and/or in communication with one or more server 212, 214 running intelligence software for facial recognition, such as BAT & ABIS 216, and/or SIPR, CIDNE, Excel & ArcGIS 218.

Embodiments of the present invention use the term cellphone to refer to any mobile communications device, including but not limited to smartphones. Similarly, the term “server” is intended to mean any computers operating as server devices and meant to include any communication networks or associated devices required for facilitating communication between the server and any device in communication with it.

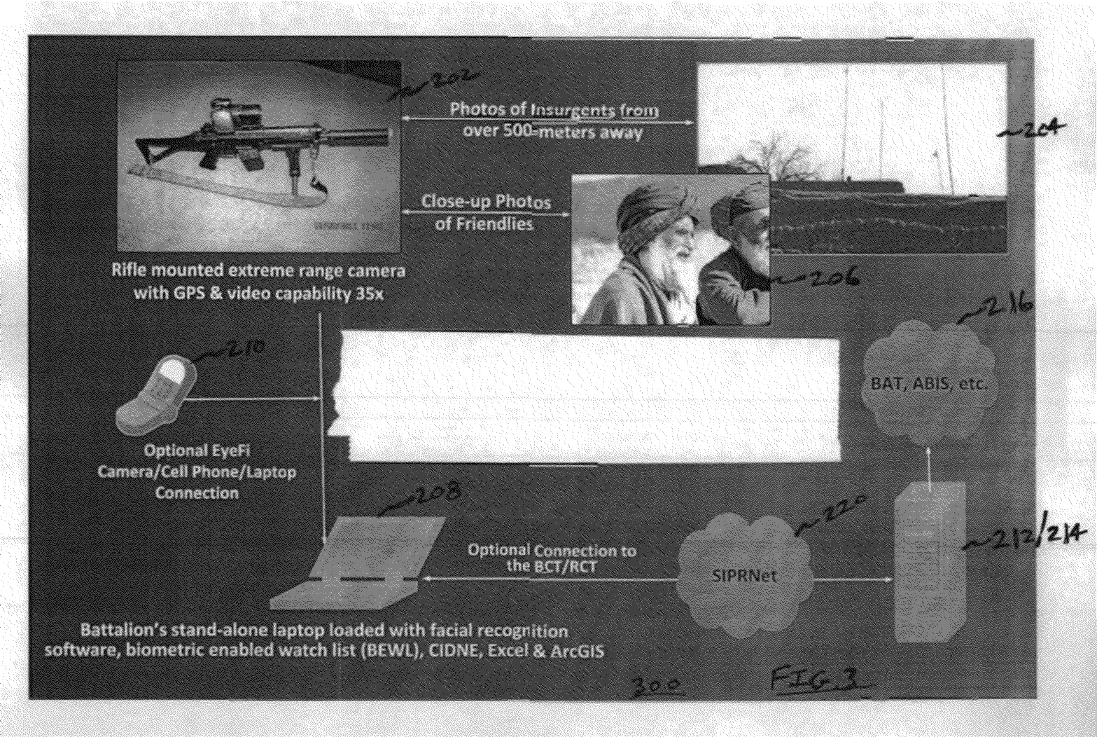

In FIG. 3, another embodiment of the system is depicted, wherein the laptop 208 is loaded with facial recognition software and a biometric enabled watch list, (“BEWL”), CIDNE, Excel & ArcGIS.

In an embodiment of the invention, camera and/or cellphone may use a global positioning system (“GPS”), or other automated system for determining the position of the camera and/or cell phone. This GPS information may then be combined with range- and direction-finding facilities either onboard the camera or provided external to the camera, to determine an estimated location of the person in the image. This location information may then be incorporated onto the digital image either by the camera's internal electronics or by the laptop's processor configured with appropriate image processing software, as is well understood in the digital, image arts. Also, in a preferred embodiment, the GPS is to military specifications and provides mil grid coordinates.

Not depicted is an optional remote switch for triggering the camera, thereby allowing the user to not need to shift their hands to take a picture. Alternatively, the camera may be remotely operated or operated directly.

In another embodiment of the invention, the camera may also serve as a scope for the assault rifle or other weapon to which it is mounted. It is understood that use of the camera as a scope requires a secure mounting.

Another embodiment of the present invention provides a method of training persons to use the inventive system and methods.

An embodiment of the present invention provides a system and method for using extreme range photography for countering insurgency and improvised explosive devices. In one embodiment, a weapons-mounted digital camera including a telephoto lens and a wireless communications interface in communication with a mobile computing device is employed. The mobile computing device may be a laptop computer or even a mobile communications device, such as a tablet computer or a smartphone. The processor and computer memory of the mobile computing device is configured to receive one or more images comprising one or more person from the camera. In an alternative embodiment, a wired communications interface may be used for communications between the camera and the mobile computing device.

In one embodiment of the invention, the camera may be controlled via a switch mounted near to the trigger of the weapon to which the camera is mounted. In alternative embodiments, the camera may also be remote-controlled, or may be controlled directly by a switch located on the camera itself.

In operation, when triggered, the camera takes photograph and the photograph is saved in a digital format. It is also envisioned that the camera may be adapted for infrared night vision capability.

In a further embodiment of the invention, the one or more images of at least one person may be forwarded to an authority external to the patrol. For example, a local person, such as a trusted individual, may be presented with the image(s) and asked to identify the one or more person therein. The external authority may alternatively be a commander or specialist associated with the patrol. Similarly, an automated system may be presented with the image(s) and employed to automatically attempt to identify the person(s) from known data. Several such systems are known in the art, for example, a facial recognition database, linke analysis chart, and facial recognition software compatible with ABIS and BAT software may be employed.

It is also envisioned that the image(s) may be compared with prior images of key persons and/or suspected insurgents for identification purposed. As mentioned, facial recognition software may be employed comparing the image(s) with those of known or suspected insurgents, and appropriate corrective action taken when insurgents are identified.

It is envisioned that in an embodiment of the invention, corrective action may be taken against the one or more person in the image(s). For example, the person(s) may simply be presented with the knowledge that they are being watched. Alternatively, they may be chemically tested for explosive residue or the like. Depending on the situation, local authorities may be provided with the image(s) or information from the image(s) in order to allow the local authorities to pursue corrective action.

In one embodiment of the invention, the one or more image(s) may be forwarded to a system for biometric identification of the person(s) in the image(s). Such biometric identification systems, such as a biometric enabled watch list, are well known in the art.

In another embodiment of the invention, an estimated location of the person(s) is determined and placed onto the image(s). For example, a global positioning system may be employed to determine the location of the camera, and the processor may then use a rangefinder and direction finder to calculate an estimated location of the person(s) in the image(s). The resultant estimated location information may then be digitally added to the image.

In another embodiment of the invention, the one or more images and calculated position information may then be forwarded to a command system for targeting of an airstrike, artillery, or the like.

In a further embodiment, the person(s) on the image may be further tracked as they move, with target updates being provided to the command targeting system.

Another embodiment of the invention provides a method of training personnel to employ extreme range photography for counter insurgency and counter improvised explosive devices is provided. Personnel to be trained are presented with a stepwise course of instruction providing training. The steps to be taught include, but are not limited to identifying the names of the villages in the personnel's area of responsibility (“AOR”), setting up a perimeter near in the AOR and meeting with local persons, photographing the local persons and any persons who watch from a distance, and storing the photographs in a database. Later, during the personnel are further taught to take extreme range photographs of suspected insurgents and use the above-described systems and methods to determine the identity of the suspected insurgents.

Exemplary specifications for a camera system useful in an embodiment of the present are as follows:

| | |
|---|---|
| Body Type | SLR-like (bridge) or Rifle Sniper Scope Type |

SENSOR

| | |
|---|---|
| Max Resolution | 4608 × 3456 |
| Image Ratio w:h | 4:3, 16:9 |
| Effective Pixels | 12.1 megapixels minimum |
| Sensor Photo | 12.1 megapixels minimum |
| Detectors | |
| Sensor Size | ½.3″ (6.17 × 4.55 mm) minimum |
| Sensor Type | BSI-CMOS of superior |
| Processor | BIONZ or superior |

IMAGE

| | |
|---|---|
| ISO | Auto, 100, 200, 400 800, 1600, 3200 |
| White Balance | 7 |
| Presets | |
| Custom White | Yes |
| Balance | |
| Image Stabilization | Optical |
| Uncompressed | No (RAW optional) |
| Format | |

OPTICS & FOCUS

| | |
|---|---|
| Focal Length | 27-810 mm minimum |
| (equiv.) | |
| Optical Zoom | 30x minimum |
| Autofocus | Contrast Detect (sensor), Multi-area, Single, |
| | Live View |
| Digital Zoom | Yes (4x) minimum |
| Manual Focus | Yes |
| Number of Focus | 9 minimum |
| Points | |
| Fileter Threads | Yes |

SCREEN/VIEWFINDER

| | |
|---|---|
| Articulated LCD | Tilting |
| Screen Size | 3″ |
| Screen dots | 921,000 |
| Touch Screen | Optional |
| Live View | Yes |
| Viewfinder Type | Electronic |

PHOTOGRAPHY FEATURES

| | |
|---|---|
| Minimum Aperture | F2.8-F5.6 |
| Minimum Shutter | 30 sec |
| Speed | |
| Maximum Shutter | 1/4000 sec |
| Speed | |
| Aperture Priority | Yes |
| Shutter Priority | Yes |
| Manual Exposure | Yes |
| Mode | |
| Subject/Scene | Yes |
| Modes | |
| Built-in Flash | Yes |
| Flash Range | 12.7 m minimum |
| External Flash | Optional |
| Flash Modes | Auto, On, Off, Slow Sync |
| Continuous Drive | Yes (10 fps) minimum |
| Self-Timer | Yes (2 or 10 sec, Portrait ½) |
| Metering Modes | Multi, Center-weighted, Spot |
| Exposure | ±2 EV (at ⅓ EV steps) |
| Compensation | |
| WB Bracketing | No |

VIDEOGRAPHY FEATURES

| | |
|---|---|
| Format | MPEG4 or superior |
| Audio Channels | Stereo |
| Clips | Yes (1920 × 1080 (60 fps), 1440 × 1080 (30 fps), |
| | 1280 × 720 (30 fps), 640 × 480 (30 fps)) |
| HD Modes | 1920 × 1080 (60 fps), 1440 × 1080 (30 fps), 1280 × |
| | 720 (30 fps), 640 × 480 (30 fps) |
| FPS | 1920 × 1080 (60 fps), 1440 × 1080 (30 fps), 1280 × |
| | 720 (30 fps), 640 × 480 (30 fps) |

STORAGE

| | |
|---|---|
| Storage Types | SD/SDHC/SDXC/Memory Stick Duo/Memory Stick |
| | Pro Duo, memory Stick Pro-HG Duo |

CONNECTIVITY

| | |
|---|---|
| USB | USB 2.0 (480 Mbit/sec) |
| HDMI | Yes |
| Wireless | Yes |
| Remote Control | Optional |

PHYSICAL

| | |
|---|---|
| Environmentally | Yes |
| Sealed | |
| Weapons Mount | Yes. Removable Picatinny Railing Mount |
| Battery Description | Lithium-Ion or four (4) AAA and charger |
| Weight (inc. | 577 g (1.27 lb/20.35 oz(approximate) |
| batteries) | |
| Dimensions | 122 × 87 × 93 mm (4.8 × 3.43 × 3.66″ |
| | (appoximate) |

OTHER FEATURES

| | |
|---|---|
| Orientation Sensor | Yes |
| Vibration Resistant | Yes. For use mounted on M4/M16 on full |
| | automatic fire |
| GPS | BuiltIn |
| Lat/Long Indicator | BuiltIn (indicates where subject is located) |
| Lens Reticle | Mil Dot |
| Windage & | BuiltIn (for use as a sniper scope) |
| Elevation | |
| Motion Detector | Yes |

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A system using extreme range photography for countering insurgency and improvised explosive devices, the system comprising:
a weapons-mounted digital camera comprising a telephoto lens and a wireless communications interface in communication with a mobile computing device;
the mobile computing device comprising a processor and computer memory, the processor and memory configured to receive one or more images comprising one or more person from the camera.

2. The system according to claim 1, wherein the camera is controlled by a switch mounted near to a trigger of the weapon to which the camera is mounted.

3. The system according to claim 1, wherein the one or more images of at least one person are then forwarded to an authority external to the patrol.

4. The system according to claim 3, wherein the one or more images further comprise information regarding the location of the at least one person.

5. The system according to claim 4, wherein location information is generated using a global positioning system (“GPS”) information in addition to information from a rangefinder and a direction finder.

6. The system according to claim 5, further comprising forwarding the image for automated biometric identity determination.

7. The system according to claim 6, wherein if the image is an insurgent, position information is forwarded to a command system for targeting.

8. A method employing extreme range photography for countering insurgency and improvised explosive devices, the method comprising:
receiving, by a ground patrol, one or more images from a weapons-mounted camera comprising a telephoto lens and a wireless communications interface in communication with a mobile computing device, the one or more images comprising one or more person and taken from a distance of more than 400 meters, and an estimated position of the one or more person;
placing information regarding the location of the one or more person onto the received image; and,
providing the one or more images to an external authority.

9. The method according to claim 8, wherein the external authority is a command system For targeting.

10. The method according to claim 9, wherein the external authority is a local person, further comprising the local person identifying the one or more persons in the one or more images.

11. The method according to claim 9, wherein the one or more images used to identify the one or more persons, and further comprising taking a corrective action against the one or more persons.

12. The method according to claim 11, wherein the corrective action comprises notifying the one or more persons that they are being observed.

13. The method according to claim 11, wherein the corrective action comprises performing a chemical analysis on the one or more person to determine is the one or more person has handled explosives.

14. The method according to claim 11, further comprising forwarding the one or more images to a system for biometric identity determination.

15. A method of training personnel to employ extreme range photography for counter insurgency and counter improvised explosive devices, the method comprising:
presenting the personnel with a stepwise course of instruction providing training in the steps of:
identifying the names of the villages in the personnel's area of responsibility (“AOR”);
setting up a perimeter near in the AOR and meeting with local persons;
photographing the local persons and any persons who watch from a distance;
storing the photographs in a database;
during patrols, taking extreme range photographs of suspected insurgents;
using a computer system to determine the identity of the suspected insurgents by comparison with the photographs in the database.
